(19) United States
(12) Patent Application Publication
(10) Pub. No.: US 2026/0340490 A1
(43) Pub. Date: Oct. 29, 2026

(54) Selection of Agentic Models for Task Completion Based on Model Interconnectivity

(71) Applicant: GDM Holding LLC, Mountain View, CA (US)

(72) Inventors: Victor Carbune, Zürich (CH); Duc-Hieu Tran, Zürich (CH); Florian Nils Hartmann, Zürich (CH)

(21) Appl. No.: 19/190,428

(22) Filed: Apr. 25, 2025

(51) Int. Cl. G06N 20/00

(52) U.S. Cl. CPC G06N 20/00

(57) ABSTRACT

Relationship information is accessed for a first user indicative of relationships between the first user and a plurality of entities. Based on the relationship information, a plurality of agentic models are identified, each of the plurality of agentic models representing a corresponding entity of the plurality of entities, an interconnectivity graph comprising a plurality of nodes connected by a plurality of edges is generated based on the relationship information. Each of the nodes represents a corresponding agentic model. Each edge comprises features derived from previous interactions associated with a pair of nodes connected by the edge, Task information indicative of a particular task requested by the first user is processed using the interconnectivity graph to obtain task routing information that identifies a first agentic model of the plurality of agentic models to complete the particular task, The task information is transmitted to the first agentic model.

### FIELD

The present disclosure relates generally to machine learning processes and machine-learned devices and systems. More particularly, the present disclosure relates to dynamically selecting model-based agents and connections between those agents based on a given task.

### BACKGROUND

A computer can receive input(s). The computer can execute instructions to process the input(s) to generate output(s) using a parameterized model. The computer can obtain feedback on its performance in generating the outputs with the model. The computer can generate feedback by evaluating its performance. The computer can receive feedback from an external source. The computer can update parameters of the model based on the feedback to improve its performance. In this manner, the computer can iteratively “learn” to generate the desired outputs. The resulting model is often referred to as a machine-learned model.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method. The computer-implemented method includes accessing, by a computing system comprising one or more processor devices, relationship information for a first user indicative of relationships between the first user and a plurality of entities. The computer-implemented method includes, based on the relationship information, identifying, by the computing system, a plurality of agentic models, each of the plurality of agentic models representing a corresponding entity of the plurality of entities. The computer-implemented method includes generating, by the computing system based on the relationship information, an interconnectivity graph comprising a plurality of nodes connected by a plurality of edges, wherein each of the plurality of nodes represents a corresponding agentic model of the plurality of agentic models, and wherein each edge of the plurality of edges comprises features derived from previous interactions associated with a pair of nodes connected by the edge. The computer-implemented method includes processing, by the computing system using the interconnectivity graph, task information indicative of a particular task requested by the first user to obtain task routing information that identifies a first agentic model of the plurality of agentic models to complete the particular task. The computer-implemented method includes transmitting, by the computing system, the task information to the first agentic model.

Another example aspect of the present disclosure is directed to a computing system that includes one or more processors and one or more non-transitory computer-readable media that store instructions that, when executed by the one or more processors, cause the computing system to perform operations. The operations include receiving task information indicative of a particular task from a user computing device. The operations include, responsive to receiving the task information, accessing an interconnectivity graph associated with a particular user of the user computing device, wherein the interconnectivity graph comprises a plurality of nodes connected by a plurality of edges, wherein each of the plurality of nodes represents a corresponding agentic model of a plurality of agentic models, wherein each of the plurality of agentic models represents a corresponding entity of a plurality of entities with relationships to the user, and wherein each edge of the plurality of edges comprises features derived from previous interactions associated with a pair of nodes connected by the edge. The operations include processing the task information with the interconnectivity graph to obtain task routing information that identifies a first agentic model of the plurality of agentic models to complete the particular task. The operations include transmitting the task information to the first agentic model.

Another example aspect of the present disclosure is directed to one or more non-transitory computer-readable media that store instructions that, when executed by one or more processors, cause the one or more processors to perform operations. The operations include accessing relationship information for a first user indicative of known relationships between the first user and a plurality of entities. The operations include, based on the relationship information, identifying a plurality of agentic models, each of the plurality of agentic models representing a corresponding entity of the plurality of entities. The operations include generating, based on the relationship information, an interconnectivity graph comprising a plurality of nodes connected by a plurality of edges, wherein each of the plurality of nodes represents a corresponding agentic model of the plurality of agentic models, and wherein each edge of the plurality of edges comprises features derived from previous interactions associated with a pair of nodes connected by the edge. The operations include processing, using the interconnectivity graph, task information indicative of a particular task requested by the first user to obtain task routing information that identifies a first agentic model of the plurality of agentic models to complete the particular task. The operations include transmitting the task information to the first agentic model.

Other example aspects of the present disclosure are directed to other systems, methods, apparatuses, tangible non-transitory computer-readable media, and devices for performing functions described herein. These and other features, aspects, and advantages of various implementations will become better understood with reference to the following description and appended claims. The accompanying drawings, which are incorporated in and constitute a part of this specification, illustrate implementations of the present disclosure and, together with the description, help explain the related principles.

### BRIEF DESCRIPTION OF THE DRAWINGS

FIG. 1 is a block diagram of a computing environment suitable for dynamic task-specific selection of model-based agents for task completion according to some implementations of the present disclosure;

FIG. 2 illustrates an example structure of nodes and edges of the interconnectivity graph of FIG. 1 according to some implementations of the present disclosure;

FIG. 3 is a communication flow diagram between a plurality of agentic models selected to complete a task according to some implementations of the present disclosure;

FIG. 4 depicts a flow chart diagram of an example method for dynamically selecting agentic models based on an interconnectivity graph according to some implementations of the present disclosure;

FIG. 5 is a flow chart diagram illustrating an example method for training a machine-learned model according to example implementations of aspects of the present disclosure;

FIG. 6 is a block diagram of an example processing flow for using machine-learned model(s) to process input(s) to generate output(s) according to example implementations of aspects of the present disclosure;

FIG. 7 is a block diagram of an example sequence processing model according to example implementations of aspects of the present disclosure;

FIG. 8 is a block diagram of an example technique for populating an example input sequence for processing by a sequence processing model according to example implementations of aspects of the present disclosure;

FIG. 9 is a block diagram of an example model development platform according to example implementations of aspects of the present disclosure;

FIG. 10 is a block diagram of an example training workflow for training a machine-learned model according to example implementations of aspects of the present disclosure;

FIG. 11 is a block diagram of an inference system for operating one or more machine-learned model(s) to perform inference according to example implementations of aspects of the present disclosure;

FIG. 12 is a block diagram of an example networked computing system according to example implementations of aspects of the present disclosure;

FIG. 13 is a block diagram of an example computing device according to example implementations of aspects of the present disclosure; and

FIG. 14 is a block diagram of an example computing device according to example implementations of aspects of the present disclosure.

### DETAILED DESCRIPTION

Generally, the present disclosure is directed to learning optimal machine learning agent selection for task completion. More specifically, personalized model-based agents (e.g., machine-learned models used to represent specific entities) can be used to autonomously complete a task. For example, if a user wishes to plan an event, the user may send a description of the desired event to a model-based agent representing an event planner. The model-based agent can then process the user’s description of the desired event to complete the task by generating an event plan for the user. The model-based agent can be a “personalized” agent that represents the event planner (e.g., plans events in a similar fashion to the event planner by selecting similar caterers, venues, etc.).

Due to the personalization applied to model-based agents, such agents can exhibit varying degrees of performance for certain types of tasks. For example, a model-based agent representing (e.g., personalized for) a mathematician may exhibit higher performance metrics for arithmetic-based tasks than a model-based agent that represents an attorney. For some tasks, a minimum degree of performance can be necessary for the task output to be useful. To follow the previous example, an 80% accuracy rate for a model-based agent performing arithmetic tasks is likely insufficient, as the corresponding output of the model-based agent would have a relatively high likelihood of being incorrect. Unfortunately, when a task is completed with an insufficient degree of quality, substantial computational costs are incurred without producing a “useful” output.

Accordingly, implementations described herein propose dynamic task-specific selection of model-based agents for task completion. For example, a computing system can access relationship information for a first user. The relationship information can indicate known relationships between the first user and a plurality of entities (e.g., a social graph indicating relationships between the user and other users, etc.). The computing system can identify a plurality of model-based agents representing corresponding entities indicated by the relationship information. For example, if the communication is a social graph that identifies two other users who are “friends” with the user on a social media platform, the computing system may identify a model-based agent that represents one of the friends while determining that a model-based agent does not exist for the other friend.

The computing system can generate an interconnectivity graph (e.g., a deterministic graph representation, a learned graph such as a graph neural network, etc.) based on the relationship information. The interconnectivity graph can include a plurality of nodes connected by a plurality of edges. Each of the nodes can represent a corresponding model-based agent, which in turn can represent a particular entity associated with the user. For example, a node of the interconnectivity graph can represent a model-based agent that represents a small business the user has previously transacted with. Each of the edges of the interconnectivity graph can connect a pair of nodes, and can include features associated with that pair of nodes. For example, an edge for a pair of nodes may include previous communications between the pair of nodes, previous interaction behavior between the pair of nodes (or the entities represented by the nodes), etc.

The computing system can process task information using the interconnectivity graph to obtain task routing information. The task information can indicate a particular task requested by the first user. The task routing information can identify a first model-based agent of the plurality of model-based agents to complete the particular task. For example, assume the task information indicates that the particular task is an arithmetic-based task. In the interconnectivity graph, a node representing the user can be connected by a first edge to a first node representing the first model-based agent. The node representing the user can be further connected by a second edge to a second node representing the second model-based agent. The computing system can evaluate the first edge and the second edge to determine whether to select the first model-based agent or the second model-based agent to complete the task. The computing system can then transmit the task information to the selected model-based agent.

Aspects of the present disclosure provide a number of technical effects and benefits. As one example technical effect and benefit, implementations described herein can reduce, or eliminate, the expenditure of computing resources associated with performance of a task with insufficient quality. As another example, implementations described herein can ensure that a maximum quality is achieved for a particular task by identifying an optimal model-based agent using the interconnectivity graph. In some implementations, implementations described herein can be used to select a model-based agent with a minimum necessary quality for task completion, therefore further reducing resource utilization.

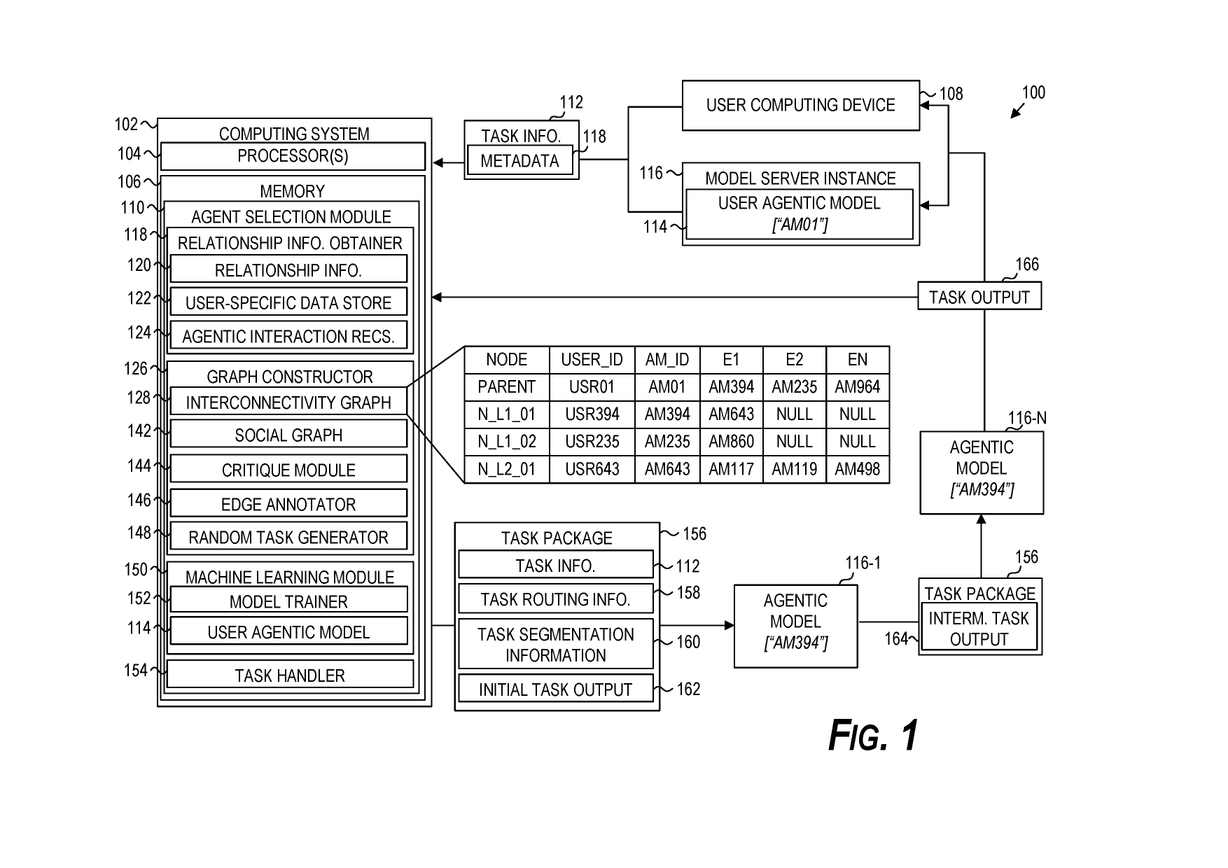

FIG. 1 is a block diagram of a computing environment suitable for dynamic task-specific selection of model-based agents for task completion according to some implementations of the present disclosure. A computing environment 100 can include a computing system 102 with one or more processor device(s) 104 and a memory 106. The computing environment 100 can include a user computing device 108 associated with a particular user (e.g., a smartphone, laptop, wearable device, etc.) of a service or organization associated with the computing system 102 (e.g., a search service, a mapping service, etc.).

In some implementations, the computing system 102 may be a computing system that includes multiple computing devices. Alternatively, in some implementations, the computing system 102 may be a plurality of distributed computing devices. The processor device(s) 104 may include any computing or electronic device capable of executing software instructions to implement the functionality described herein.

The memory 106 can be or otherwise include any device(s) capable of storing data, including, but not limited to, volatile memory (random access memory, etc.), non-volatile memory, storage device(s) (e.g., hard drive(s), solid state drive(s), etc.). In some implementations, the memory 106 can include a containerized unit of software instructions (i.e., a “packaged container”). The containerized unit of software instructions can collectively form a container that has been packaged using any type or manner of containerization technique. A containerized unit of software instructions can include one or more applications, and can further implement any software or hardware necessary for execution of the containerized unit of software instructions within any type or manner of computing environment. For example, the containerized unit of software instructions can include software instructions that contain or otherwise implement all components necessary for process isolation in any environment (e.g., the application, dependencies, configuration files, libraries, relevant binaries, etc.).

In some implementations, the computing environment 100 can include multiple types of nodes. As described herein, a “node” generally refers to a discrete unit of hardware and/or software resources. In some instances, nodes within the computing environment 100 can be configured to perform specific tasks. For example, some nodes within the confidential computing environment 100 can be configured as “compute” or “processing” nodes that handle processing tasks or provide processing-heavy services. Compute nodes are generally allocated with hardware devices that can facilitate processing tasks, such as Graphics Processing Units (GPUs), Central Processing Units (CPUs), Application-specific Integrated Circuits (ASICs), Field-Programmable Gate Arrays (FPGAs), etc.

Conversely, storage nodes can be allocated with hardware devices to facilitate storage tasks, such as storage devices (e.g., hard drives, etc.), memory, high-bandwidth network devices, physical storage media, etc.). It should be noted that in some instances, storage nodes can include processing devices (e.g., CPUs, etc.) to facilitate storage operations (e.g., read/write operations) and processing nodes can include storage devices (e.g., random access memory) to facilitate processing operations.

The memory 106 can include an agent selection module 110. The agent selection module 110 can dynamically select agentic models (e.g., neural networks, sequence processing models, etc.) to complete certain tasks. More specifically, the agent selection module 110 can receive task selection information 112. The task selection information 112 can specify a particular task for completion. A “task” may refer to a request to process data (e.g., to generate an output, retrieve data, classify data, etc.), a query, a prompt, a set of instructions, etc. In some implementations, the task information 112 can be received by the agent selection module 110 from the user computing device 108 associated with the user. For example, the user may input a query to the user computing device 108, and the user computing device 108 can include the query in the task information 112.

Alternatively, in some implementations, the task information 112 can be received by the agent selection module 110 from an agentic model 114. As described herein, an “agentic model” refers to a machine-learned model (or set of machine-learned models), such as a sequence processing model, that represents a particular entity (e.g., a user, a service, an organization, a brand, a fictional character, etc.). In some implementations, to represent the particular entity, the agentic model may be prompted to generate outputs from the perspective of the entity (e.g., “answer queries as if you were a particular fictional character.”). Additionally, or alternatively, in some implementations, the machine-learned model can receive contextual information related to the entity represented by the model. For example, if representing an internet service provider (e.g., a video streaming service, mapping service, search service, etc.), the agentic model may be provided with information related to service offerings of the service provider (e.g., costs associated with certain offerings, answers to frequently asked questions, content guidelines, etc.).

In some implementations, the agentic model 114 (hereinafter referred to as the “user model” 114) can represent the user of the user computing device 108. For example, the user model 114 can be instructed to generate outputs from the perspective of the user, and can be provided contextual information related to the user.

In some implementations, the user model 114 can be executed on a model server instance 116. A “model server instance” can refer to a set of hardware and software resources used to execute one or more instances of the user model 114 (e.g., processor resources, memory, network bandwidth, etc.). For example, the user model 114 may be executed at a local node comprising resources from the processor device(s) 104 and the memory 106 of the computing system 102 (e.g., physical resources located closer to a location of the user computing device 108 than other resources).

In some implementations, the task information 112 can include metadata 118. The metadata 118 can include information related to the user computing device 108 to be processed alongside the task information 112. For example, the metadata 118 can include a current battery level, available bandwidth, processor utilization, etc. In some implementations, the metadata 118 can identify a particular application that received the input from the user. For example, if the user requested a task via a virtual assistant application, the metadata 118 can identify the virtual assistant application. For another example, if the task was requested automatically by a search application without receiving a user input, the metadata can identify the search application and the automatic (i.e., non-user prompted) status of the request. In some implementations, if the task information 112 is provided by the user model 114, the task information 112 as being generated by a machine-learned model.

As described previously, the agent selection module 110 can select between multiple agentic models to complete a task. Such selections can be based on model availability, the type of task requested, prior indications of task-specific quality received from agentic models (i.e., a degree of performance previously exhibited by an agentic model when completing certain types of tasks), etc. The agentic models selected by the agent selection module 110 can belong to a plurality of agentic models 116-1 – 116-N (generally, agentic models 116) that represent corresponding entities with known relationships with the user. As described herein, an “relationship” refers to some prior interaction between the user, the entity, the user model 114, and/or the agentic model 116 representing the entity. For example, a purchase by the user from an online retailer would be a “relationship” between the user and the online retailer. For another example, a streaming content item accessed by the user from a streaming service provider would be a relationship between the user and the user service provider. For another example, an automatic query transmitted by the user model 114 to the same streaming service provider would be a relationship between the user and the streaming service provider. For yet another example, an automatic query transmitted by the user model 114 to one of the agentic models 116 that represents the same streaming service provider would also be a relationship between the user and the streaming service provider.

The agent selection module 110 can include a relationship information obtainer 118. The relationship information obtainer 118 can obtain relationship information 120. The relationship information 120 can be indicative of relationships between the first user and the plurality of entities. For example, if the user previously purchased a good from an online service, the relationship information 120 may include (or otherwise describe) a receipt from the interaction, a description of the purchased good, identifying information for the online service, identifying information for the purchased product, an encoding that represents the transaction, etc. For another example, if the user agentic model 114 submitted a query and received a response from one of the agentic models 116 representing a network service provider, the relationship information 120 may include (or otherwise describe) the query, the response, information identifying the agentic model, information identifying the network service provider, a timestamp for transmission of the query, a timestamp for receipt of the response, etc.

In some implementations, the associated information obtainer 118 can access a user-specific data store 122. The user-specific data store 122 can store user-specific data (specific to either the user of the user computing device 108 or users represented by the agentic models 116). In particular, the user-specific data store 122 can store user-specific data in a privacy preserving manner. For example, if the relationship information 120 retrieved from the user-specific data store 122 identifies a particular user, the identifying information can be encoded, scrubbed, modified, blurred, etc. to preserve the privacy of the particular user. Further, it should be noted that none of the user-specific information described in the present disclosure is stored to the user-specific data store 122, retrieved from the user-specific data store 122, and/or processed with a machine-learned model without receipt of explicit user permission. For example, prior to storage of identifying information, the user can provide consent for storage of such material via the user computing device 108.

In some implementations, the user-specific data store 122 can include textual content related to interactions between the user and other users represented by the agentic models 116. For example, assume that the user collaborated with another user within a shared document while working together on an assignment. The user-specific data store 122 can include textual content, such as comments, revisions, chat history, etc. originating from the user’s interactions within the shared document. Additionally, or alternatively, in some implementations, the user-specific data store can include non-textual content. For example, if users collaborate on a media project using certain tools (e.g., virtual brushes, color palettes, etc.), the user-specific data store may include information descriptive of tool usage, tool configurations (e.g., brush width, etc.), etc. For another example, if users interact in a three-dimensional virtual space (e.g., using Augmented Reality / Virtual Reality (AR/VR) technologies, the user-specific data store may include information descriptive of the users movements and actions within the virtual space. For yet another example, the user-specific data store 122 can store data related to collaborative sessions between users, such as calendar invites, meeting duration and frequency, typical attendance, etc.).

The associated information obtainer 118 can access agentic interaction recordings 124. The agentic interaction recordings 124 can be (or otherwise be indicative of) prior interactions between the user model 114 and one or more of the agentic models 116. For example, if the user model 114 conversed with the agentic model 116-1 while completing a task, the conversation can be stored to the agentic interaction recordings 124.

The agent selection module 110 can include a graph constructor 126. The graph constructor 126 can construct or otherwise generate an interconnectivity graph 128 based on the relationship information 120. As described herein, an “interconnectivity graph” refers to a graph representing the relationships between the user model 114 and the agentic plurality of entities known to the user (e.g., other users, businesses, organizations, educational institutions, etc.). More specifically, the interconnectivity graph 128 can include a plurality of nodes and a plurality of edges. Each of the nodes can represent a corresponding agentic model of the agentic models 116 that represents a user known to the user of the user computing device 108. Each of the edges can connect pairs of nodes, and can include features derived from previous interactions associated with the pair of nodes.

In some implementations, the interconnectivity graph 128 can be a data structure that stores data related to other entities known to the user, previous interactions with such entities or with agentic models representing such entities, features extracted from such interactions, etc. For example, the interconnectivity graph 128 may include derived characteristics reflecting the nature of prior interactions between entities represented by connected nodes, such as interaction frequency or collaborative patterns. Additionally, or alternatively, in some implementations, the interconnectivity graph 128 can be a learned interconnectivity graph. For example, the interconnectivity graph 128 may be a graph neural network or may otherwise include portions of a graph neural network. For another example, the interconnectivity graph 128 may include learned values that are trained based on prior selections of agentic models and corresponding outputs of such models.

For example, assume that a node (e.g., a parent node) representing the user model 114 is connected to another node representing the agentic model 116-1. Further assume that the agentic model 116-1 represents a friend of the user of the user computing device 108. The edge connecting the pair of nodes can include features derived from previous interactions between the user and their friend, the user model 114 and the agentic model 116-1, or any mix thereof. For example, the features of the edge connecting the node may be based on the history of collaborative activity between the two users within a shared document. For another example, the features of the edge may include a summary of revisions made by one user to the other user’s work.

In some implementations, the nodes, the edges, or both, can include learned values or parameters that can be adjusted over time based on the quality of outputs received from the agentic models 116 represented by the nodes. In some implementations, the learned parameters can be (or include) values (e.g., weights, scores, etc.) corresponding to particular types of tasks. For example, assume that the agent selection module 110 selects the agentic model 116-1 for a variety of text-related tasks (e.g., summarization, critical analysis, commentary, etc.). For each requested task, the agent selection module 110 can receive a task output from the agentic model 116-1 and can evaluate a “quality” of the task (e.g., with the user model 114, based on user feedback, etc.). Based on the quality of the task output, over time, the agent selection module can adjust a value representing a degree of “quality” from the model when completing tasks of that particular type.

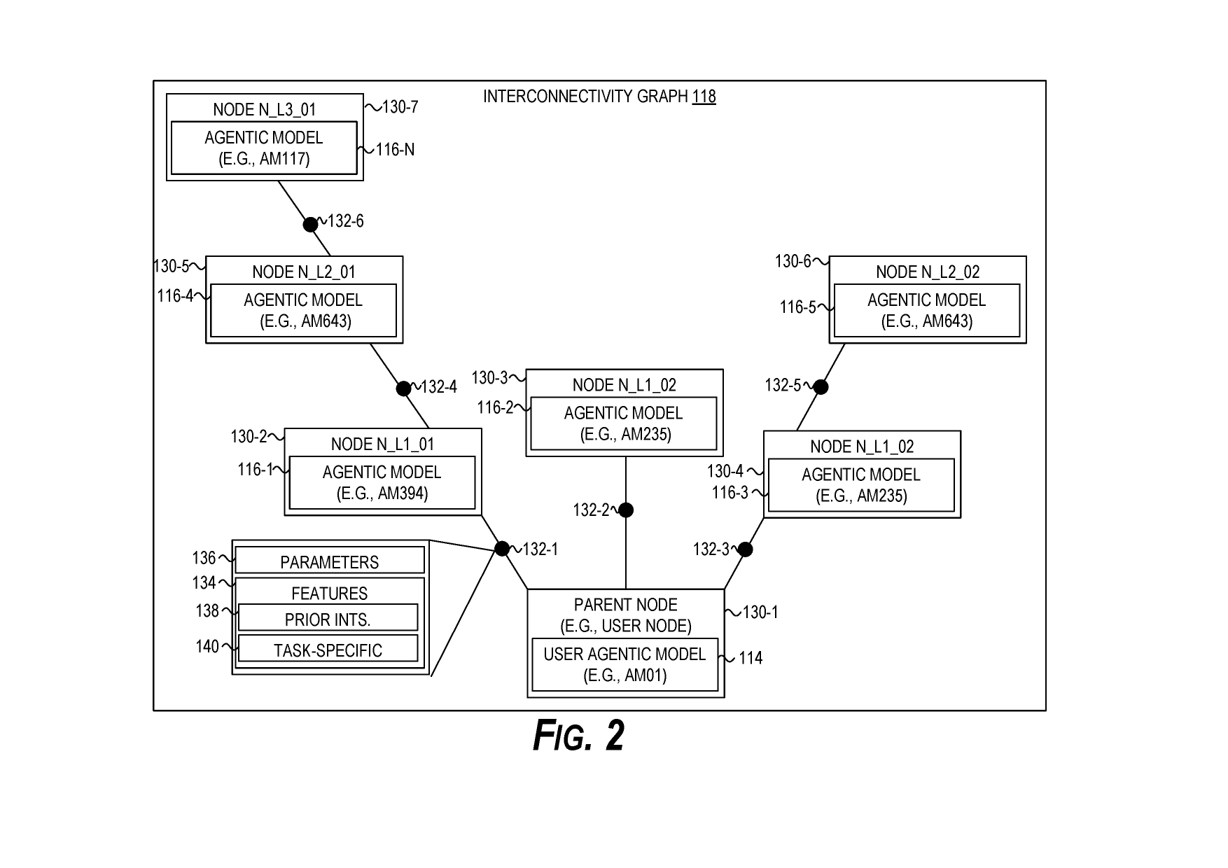

More specifically, turning to FIG. 2, FIG. 2 illustrates an example structure of nodes and edges of the interconnectivity graph 128 of FIG. 1 according to some implementations of the present disclosure. The interconnectivity graph 128 can include a plurality of nodes 130-1 – 130-N and a corresponding plurality of edges 132-1 – 132-N. As depicted, the node 130-1 (also referred to interchangeably herein as the “parent” node 130-1) can represent the user model 114. The node 130-2 can represent the agentic model 116-1, the node 130-2 can represent the agentic model 116-2, the node 130-3 can represent the agentic model 116-3, etc.

Each of the nodes can be connected to another node via one or more of the edges 132. For example, the parent node 130-1 can be connected to the node 130-2 via edge 132-1, the node 130-3 via the edge 132-2, and the node 130-4 via the edge 132-3. The edges 132 can each include features derived from previous interactions associated with a pair of nodes connected by the edge. For example, the edge 132-1 can include features 134. The features 134 can be derived from previous interactions between the node 130-2 and the node 130-2. As described herein, previous interactions associated with a pair of nodes refers to interactions between a pair of agentic models respectively represented by the pair of nodes, and/or a pair of entities respectively represented by the pair of agentic models. For example, the features 134 may be derived from interactions between the user model 114 and the agentic model 116, the user of the user computing device 108 represented by the user model 114, a user represented by the agentic model 116-1, etc.

In some implementations, the edge 132-1 can include parameters 136. The parameters 136 can be learned parameters or values that can be adjusted based on a measured “performance” of the agentic model 16-1 over time. It should be noted that, although the parameters 136 are illustrated as being included in the edge 132-1, in some implementations, the parameters 136 may instead be included in the parent node 130-1. In some implementations, the interconnectivity graph 118 can be a graph neural network (GNN), and the parameters 136 can be parameters of the GNN.

In some implementations, the features 134 can include prior interaction features 138. The prior interaction features 138 can be derived from the previous interactions associated with the pair of nodes 130-1 and 130-2. In some implementations, the features 134 can include task-specific features 140. The task-specific features 140 can be derived from task-specific information, such as outputs corresponding to specific task requests previously provided to the model connected by the edge. For example, the task-specific features 140 for the edge 132-1 can be derived from previous task outputs provided by the agentic model 116-1 connected by the edge 132-1.

As depicted, the interconnectivity graph 118 can include multiple “layers” of the nodes 130 connected hierarchically by the edges 132. For example, the parent node 130-1 can be connected to the node 130-2 by the edge 132-1. The node 130-2 can be connected to the node 130-5 by the edge 132-4. Edges representing pairs of non-parent nodes, such as the edge 132-4, can represent prior instances in which a portion of a task delegated to one of the paired nodes by the parent node was further delegated by that node to the other paired node. For example, assume the parent node 130-1 delegates a task to the node 130-2. While completing the task, the node 130-2 (e.g., the agentic model 116-1 represented by the node 130-2) may further delegate a portion of the task to the node 130-5. The node 130-5 (e.g., the agentic model 116-4 represented by the node 130-5) can complete the portion of the task to generate a task output (or a portion thereof). The features of the edge 132-4 can be derived based on the portion of the output generated by the agentic model 116-4 represented by the node 130-5.

The graph constructor 126 of FIG. 1 can initially construct the interconnectivity graph 118 based on the relationship information 120. For example, the relationship information 120 can indicate relationships between the user of the user computing device 108 and a plurality of entities known to the user. The graph constructor 126 can first filter some (if necessary) of the plurality of entities if the filtered entities do not have corresponding agentic models. The graph constructor 126 can then create nodes representing the agentic models of each remaining entity. The graph constructor 126 can create the edges 132 between the nodes 130 based on the relationship information. In some implementations, the graph constructor 126 can do so based on a relationship criteria. For example, if the frequency of prior interactions between two agentic models is greater than a threshold frequency, the graph constructor 126 can create an edge between two nodes representing the two agentic models.

Returning to FIG. 1, in some implementations, the graph constructor 126 can initially create the interconnectivity graph 118 based on an existing social graph 142. The existing social graph 142 can be information extracted from a social network, the user’s contacts, etc. For example, the social graph 142 can be a list of friends of the user across one or more social networks. In some implementations, the social graph 142 can be processed using the user model 114 to generate the interconnectivity graph 128.

In some implementations, the graph constructor 126 can include a critique module 144. The critique module 144 can evaluate (i.e., critique) the interconnectivity graph 128 over time, and can modify the interconnectivity graph 128 based on the evaluation. For example, the critique module 144 can create new nodes to represent new agentic models, add or delete edges between nodes, etc. For example, assume the critique module 144 initially creates the edge 132-2 between the parent node 130-1 and the node 130-3. If the task outputs received from the node 130-3 (e.g., the agentic model 116-2 represented by the node 130-3) are of substantially lower quality than other nodes, the critique module 144 may remove the edge 132-2. For example, the critique module 144 may remove the edge 132-2 if a quality score associated with the node 130-3 is lower than a threshold score for a period of time.

In some implementations, the graph constructor 126 can include an edge annotator 146. The edge annotator 146 can annotate the edges 132 with additional information or features 134 over time. For example, if the user represented by the user model 114 collaborates on a new project with a user represented by the agentic model 116-1 (or if the models collaborate on a project directly), the edge 132-1 between the nodes representing those models can be annotated with features extracted from the information generated when the users collaborated.

In some implementations, the graph constructor can include a random task generator 148. The random task generator 148 can generate random tasks (i.e., “synthetic” tasks) for the agentic models 116. These random tasks can be used to evaluate a degree of performance exhibited by the agentic models 116. For example, the random tasks can be used to establish a baseline performance for each of the agentic models 116 for a variety of tasks. For a more specific example, the random task generator 148 may generate a prompt and a set of instructions that instruct the recipient model to perform different types of text-based tasks with the prompt (e.g., summarize the prompt, critique the prompt, visualize the prompt, etc.). The random task generator 148 can receive the outputs of the different types of tasks from each of the agentic models 116, and can rank the models performance for each type of task to establish a baseline “ranking” of quality for each task type.

The agent selection module 110 can include a machine learning module 150. The machine learning module 150 can perform various machine-learning tasks, such as training or fine-tuning machine-learned models, instantiating machine-learned models, etc. For example, the machine learning module 150 may include a model trainer 152 and may use the model trainer 152 to train the user model 114. For another example, the machine learning module 150 may instantiate the user model 114 on the model server instance 116 (e.g., by allocating resources to create the model server instance 116, etc.).

In some implementations, if the interconnectivity graph 128 includes adjustable parameters (e.g., weights for neurons of a GNN, etc.), the machine learning module 150 can use the model trainer 152 to train the interconnectivity graph 128 in conjunction with the critique module 144 and the random task generator 148. For example, the model trainer 152 can receive evaluation signals from the critique module 144 and can adjust the parameters of the interconnectivity graph 128 based on those evaluation signals. In some implementations, the machine learning module 150 can include the user model 114 (or an instance thereof). Additionally, or alternatively, in some implementations, the user model 114 can be instantiated on the model server instance 116 separately from the computing system 102. In some implementations, the user model 114 (or a distilled version thereof) can be executed on the user computing device 108.

The agent selection module 110 can include a task handler 154. The task handler 154 can evaluate the interconnectivity graph 128 and the task information 112 to generate a task package 156. The task package 156 can include the task information 112 (or some portion thereof). The task package 156 can also include task routing information 158 generated by the task handler 154. The task routing information 158 can specify one or more of the agentic models 116 to complete the task specified by the task information 112. For example, the user model 114 can process the task information 112 to identify a particular type or classification associated with the task. The user model 114 can then evaluate the interconnectivity graph to identify one or more agentic models to complete the task based on various criteria (e.g., the task type scores associated with the agentic model, a cost associated with the agentic model, etc.).

In some implementations, the task package 156 can also include task segmentation information 160 generated by the task handler 154. The task segmentation information 160 can segment the task specified by the task information 112 into a plurality of sub-tasks. In conjunction, the task routing information 158 can indicate a sequence in which the sub-tasks are to be completed, and can assign the sub-tasks to particular agentic models. The task routing information 158 can include instructions that instruct each agentic model to perform a specified sub-task. The task routing information 158 can further include instructions to communicate sub-task outputs to particular models for further completion of sub-tasks. To follow the illustrated example, assume that the task segmentation information 160 segments the task into three sub-tasks. Further assume that the task routing information 158 assigns the first sub-task to the user model 114, the second sub-task to the agentic model 116-1, and the third sub-task to the agentic model 116-N. The user model 114 can process the task information to generate an initial task output 162, which can be included in the task package 156. The task package 156 can be provided to the agentic model 116-1, which can process the task package 156 to generate an intermediate task output 164. The agentic model 116-1 can include the intermediate task output in the task package 156 and can provide the task package 156 to the agentic model 16-N. The agentic model 16-N can process the task package 156 to generate a “final” task output 166. The task output 166 can represent a “complete” output that fulfills the task specified by the task information 112. The task output 166 can be provided to the computing system 112, the user model 114, and/or the user computing device 108.

It should be noted that, in some implementations, some (or all) of the functionality described with regards to the modules of the agent selection module 110 can be performed using the user model 114. For example, the user model 114 may process the relationship information 120 to generate the interconnectivity graph 128. For another example, the user model 114 may be used to generate random tasks as described with regards to the random task generator 148. For yet another example, the user model 114 may process the task information 112 to generate the task package 156.

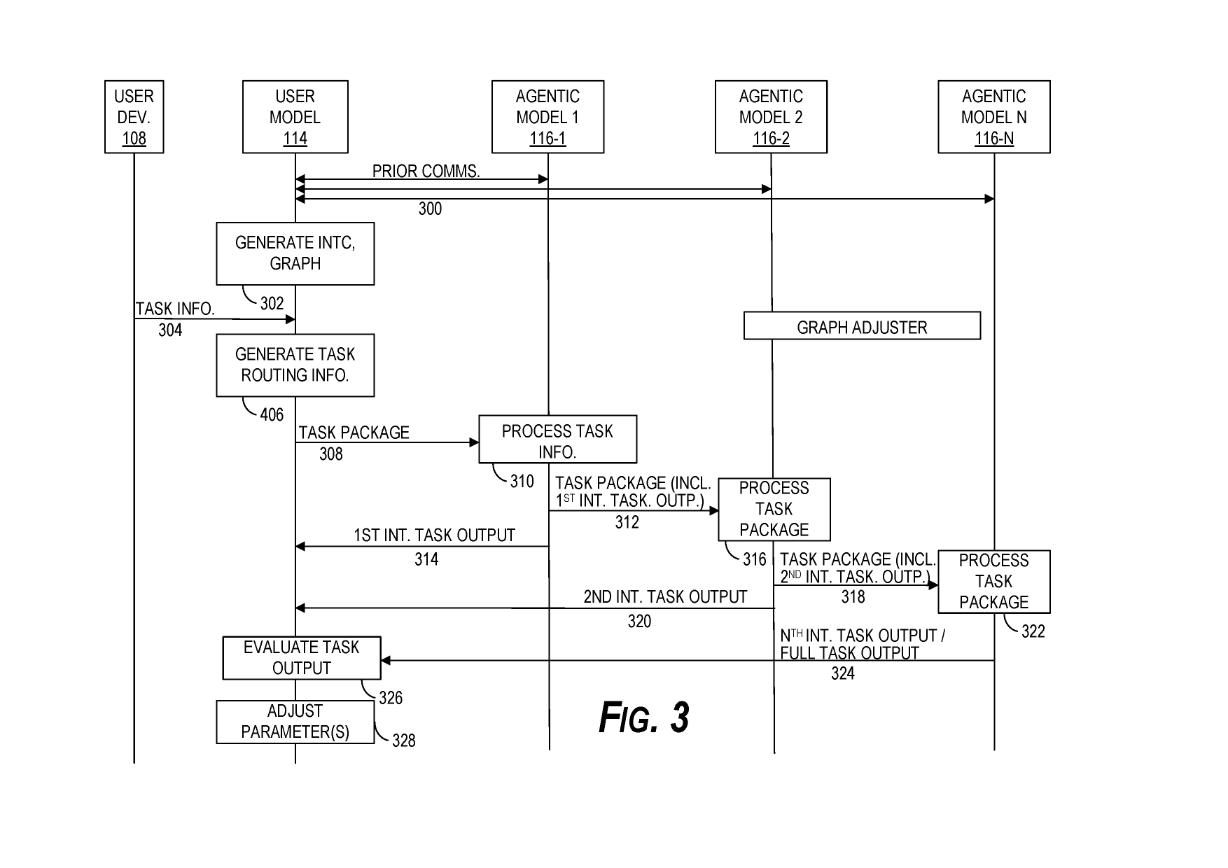

FIG. 3 is a communication flow diagram between a plurality of agentic models selected to complete a task according to some implementations of the present disclosure. FIG. 3 will be discussed in conjunction with FIG. 1. More specifically, at 300, the user model 114 can participate in a set of interactions with the agentic models 116-1, 116-2, and 116-N.

At 302, the user model 114 can generate the interconnectivity graph 128 by processing the relationship information 120 as described with regards to FIG. 1. At 304, the user model 114 can receive the task information 112 from the user computing device 108.

At 306, the user model 114 can generate task routing information 158 based on the task information 112 and the interconnectivity graph 128. In some implementations, the user model 114 may process the task information 112 and the interconnectivity graph 128 (or information retrieved therefrom) to generate the task routing information 158 as an output of the model. For example, the user model 114 may process the task information 112 to identify a task type of the requested task. The user model 114 may search the interconnectivity graph 128 to identify one or more agentic models exhibiting high performance on tasks of that type.

Assume that the task routing information 158 specifies the agentic models 116-1, 116-2, and 116-N to complete the task. At 308, the user model 114 can send the task package 156 to the agentic model 116-1. In response, at 310, the agentic model 116-1 can process the task information 112 to generate a first intermediate task output. At 312, the agentic model 116 can transmit the first intermediate task output to the agentic model 116-2 to facilitate task completion. Additionally, in some implementations, at 314, the agentic model 116-1 can transmit the first intermediate task output back to the user model 114. At 316, the agentic model 116-2 can process the first intermediate task output to generate a second intermediate task output. In some implementations, the agentic model 116-2 can process the task information 112, the task routing information 158, and/or the task segmentation information 160 alongside the first intermediate task output.

For example, assume that the task is to identify a movie in a movie poster, retrieve information about the movie, and then generate a summary of the movie. The agentic model 116-1 may be a model that specializes in identifying content, and as such, the first intermediate task output can identify the movie. The agentic model 116-2 may be a model that specializes in retrieving information. As such, the agentic model 116-2 can process the first intermediate task output that identifies the movie to retrieve information about the movie.

At 318, the agentic model 116-N can transmit the second intermediate task output to the agentic model 116-N to facilitate task completion. More specifically, the agentic model 116-2 can add the second intermediate task output to the “task package” received from the agentic model 116-1 (that includes the first intermediate task output), and can “forward” the task package to the agentic model 116-N. Additionally, in some implementations, at 320, the agentic model 116-2 can transmit the second intermediate task output back to the user model 114. At 322, the agentic model 116-N can process the second intermediate task output to generate a N^{th} intermediate task output. In some implementations, the agentic model 116-N can process the task information 112, the task routing information 158, the task segmentation information 160, and/or the first intermediate task output alongside the second intermediate task output.

At 324, the agentic model 116-N can transmit the N^{th} intermediate task output to the user model 114. In some implementations, the agentic model 116-N can transmit the “final” or “complete” task output 166 to the user model 114 by combining the N^{th} intermediate task output with the second intermediate task output and the first intermediate task output. At 326, the user model 114 can evaluate the task output 166 (e.g., with the critique module 144, etc.). At 328, based on the evaluation, the user model 114 can adjust parameters of the interconnectivity graph 128.

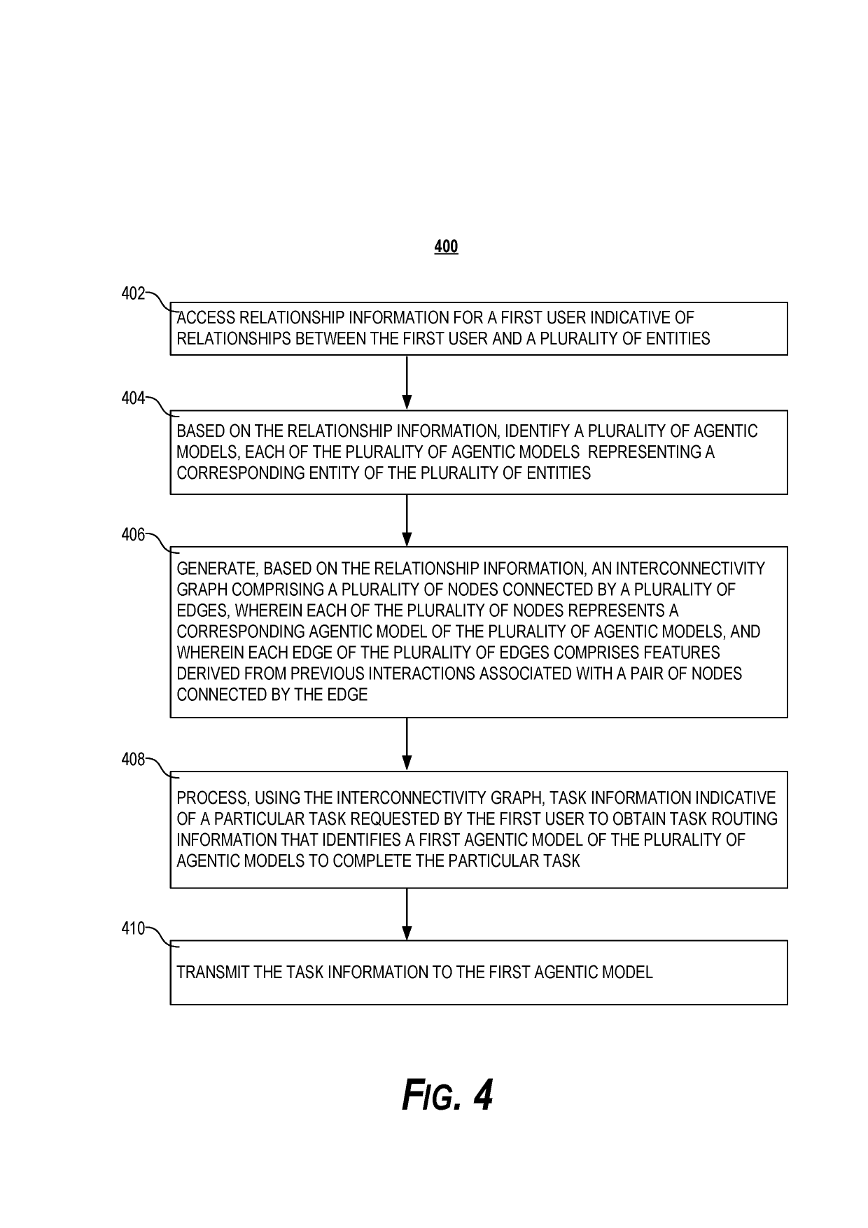

FIG. 4 depicts a flow chart diagram of an example method 400 for dynamically selecting agentic models based on an interconnectivity graph according to some implementations of the present disclosure. Although FIG. 4 depicts steps performed in a particular order for purposes of illustration and discussion, the methods of the present disclosure are not limited to the particularly illustrated order or arrangement. The various steps of the method 400 can be omitted, rearranged, combined, and/or adapted in various ways without deviating from the scope of the present disclosure.

At 402, a computing system can access relationship information for a first user indicative of relationships between the first user and a plurality of entities.

At 404, the computing system can, based on the relationship information, identify a plurality of agentic models, each of the plurality of agentic models representing a corresponding entity of the plurality of entities.

At 406, the computing system can generate, based on the relationship information, an interconnectivity graph can include a plurality of nodes connected by a plurality of edges. Each of the plurality of nodes can represent a corresponding agentic model of the plurality of agentic models. Each edge of the plurality of edges can include features derived from previous interactions associated with a pair of nodes connected by the edge.

At 408, the computing system can process, using the interconnectivity graph, task information indicative of a particular task requested by the first user to obtain task routing information that identifies a first agentic model of the plurality of agentic models to complete the particular task.

At 410, the computing system can transmit the task information to the first agentic model. In some implementations, the computing system can receive a first task output from the first agentic model. In some implementations, the computing system can evaluate the first task output from the first agentic model to obtain a first quality score for the first task output. The computing system can adjust the interconnectivity graph based on the first quality score for the first task output.

In some implementations, to adjust the interconnectivity graph, the computing system can transmit the task information to a second agentic model different than the first agentic model. The computing system can receive a second task output from the second agentic model and evaluate the second task output from the second agentic model to obtain a second quality score for the second task output. Responsive to the second quality score for the second task output being greater than the first quality score for the first task output, the computing system can adjust one or more parameters. The one or more parameters can be associated with at least one of a first edge of the plurality of edges that connects a first node associated with the first user to a second node associated with the first agentic model, or a second edge of the plurality of edges that connects the first node associated with the first user to a third node associated with the second agentic model. In some implementations, a first parameter of the one or more parameters can include a feature of the first edge.

In some implementations, the first task output can include a request for assistance with the particular task. The computing system can process the first task output using the interconnectivity graph to identify a second agentic model. The computing system can transmit information indicative of the second agentic model to the first agentic model. The computing system can receive a complete task output including the first task output and a second task output generated by the second agentic model.

In some implementations, the plurality of edges can include a first edge that connects a first node to a second node of the plurality of nodes, the first node can represent a agentic model associated with the first user, and the second node can represent the first agentic model of the plurality of agentic models.

In some implementations, the first edge can include a plurality of features, such as a communication between the agentic model associated with the first user and the first agentic model, a communication between the first user and a first entity of the plurality of entities represented by the first agentic model, or task-specific scoring information. The task-specific scoring information can include a plurality of task scores for a respective plurality of task classifications, each of the plurality of task scores being indicative of an expected output quality for the first agent-based model when completing a task of a corresponding task classification.

In some implementations, the plurality of features can include the task-specific scoring information, and to process the task information indicative of the particular task requested by the first user using the interconnectivity graph, the computing system can process the task information to identify a particular task classification of the plurality of task classifications for the particular task. The computing system can select the first agentic model from the plurality of agentic models based on the task-specific scoring information.

The computing system can receive information indicative of a new communication between the agentic model associated with the first user and the first agentic model. The computing system can adjust the first edge of the interconnectivity graph based on the information indicative of the new communication.

In some implementations, to adjust the first edge of the interconnectivity graph, the computing system stores at least a portion of the new communication to the first edge of the interconnectivity graph. In some implementations, the plurality of features further includes the task-specific scoring information. To adjust the first edge of the interconnectivity graph, the computing system adjusts a first task score of the plurality of task scores based on the new communication between the agentic model associated with the first user and the first agentic model. In some implementations, to adjust the first edge of the interconnectivity graph, the computing system can remove the first edge from the interconnectivity graph.

In some implementations, the task routing information identifies a plurality of agentic models including the first agentic model and a second agentic model. The second agentic model is connected to the first agentic model by a second edge of the plurality of edges within the interconnectivity graph.

In some implementations, the task routing information assigns a first portion of the particular task to the first agentic model. The task routing information further assigns a second portion of the particular task to the second agentic model. In some implementations, the plurality of entities includes a second user different than the first user. The relationship information includes information descriptive of a previous exchange between the first user and the second user.

Various example implementations are described herein with respect to the accompanying Figures.

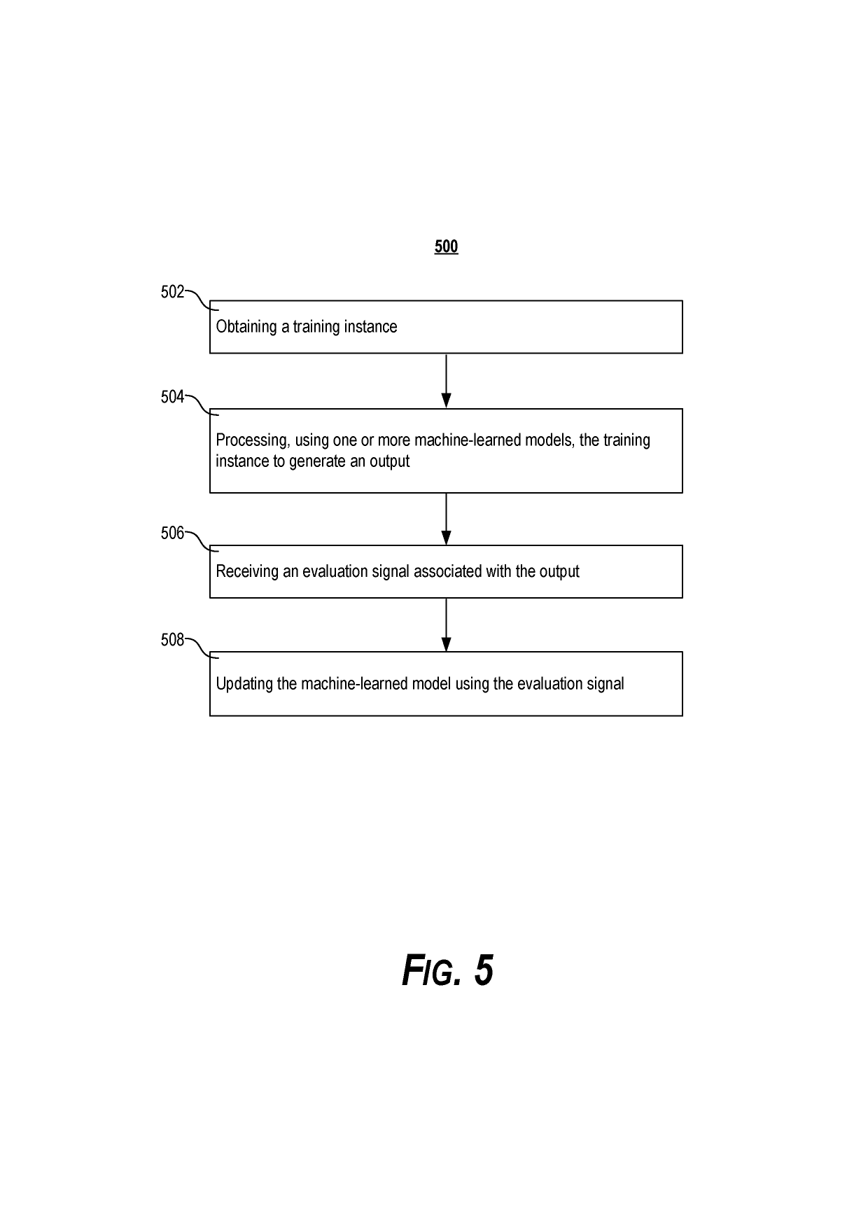

FIG. 5 depicts a flowchart of a method 500 for training one or more machine-learned models according to aspects of the present disclosure. For instance, an example machine-learned model can include an agentic model, or an interconnectivity graph.

One or more portion(s) of example method 500 can be implemented by a computing system that includes one or more computing devices such as, for example, computing systems described with reference to the other figures. Each respective portion of example method 500 can be performed by any (or any combination) of one or more computing devices. Moreover, one or more portion(s) of example method 500 can be implemented on the hardware components of the device(s) described herein, for example, to train one or more systems or models. FIG. 5 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 5 is described with reference to elements/terms described with respect to other systems and figures for exemplary illustrated purposes and is not meant to be limiting. One or more portions of example method 500 can be performed additionally, or alternatively, by other systems.

At 502, example method 500 can include obtaining a training instance. A set of training data can include a plurality of training instances divided between multiple datasets (e.g., a training dataset, a validation dataset, or testing dataset). A training instance can be labeled or unlabeled. Although referred to in example method 500 as a “training” instance, it is to be understood that runtime inferences can form training instances when a model is trained using an evaluation of the model’s performance on that runtime instance (e.g., online training/learning). Example data types for the training instance and various tasks associated therewith are described throughout the present disclosure.

At 504, example method 500 can include processing, using one or more machine-learned models, the training instance to generate an output. The output can be directly obtained from the one or more machine-learned models or can be a downstream result of a chain of processing operations that includes an output of the one or more machine-learned models.

At 506, example method 500 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 508, example method 500 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 500 can include implementing a number of generalization techniques (e.g., weight decays, dropouts, etc.) to improve the generalization capability of the models being trained.

In some implementations, example method 500 can be implemented for training a machine-learned model from an initialized state to a fully trained state (e.g., when the model exhibits a desired performance profile, such as based on accuracy, precision, recall, etc.).

In some implementations, example method 500 can be implemented for particular stages of a training procedure. For instance, in some implementations, example method 500 can be implemented for pre-training a machine-learned model. Pre-training can include, for instance, large-scale training over potentially noisy data to achieve a broad base of performance levels across a variety of tasks/data types.

In some implementations, example method 500 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). In some implementations, example method 500 uses adapter modules. Adapters can be small trainable layers that are inserted between pre-existing layers of a pre-trained model. During the fine-tuning process, the original parameters of the pre-trained model are typically frozen, and only the parameters of the adapters are updated.

In some implementations, example method 500 can be implemented to execute parameter-efficient fine-tuning methods, such as Low-Rank Adaptation (LoRA). LoRA can refine pre-trained models with minimal adjustments to the original parameters. This can be achieved by introducing trainable low-rank matrices that modify the behavior of the pre-trained weights without directly altering them. In some implementations, during fine-tuning, only these auxiliary matrices are updated, which significantly reduces the number of parameters that are trained.

An example fine-tuning approach includes reinforcement learning. Reinforcement learning can be based on user feedback on model performance during use.

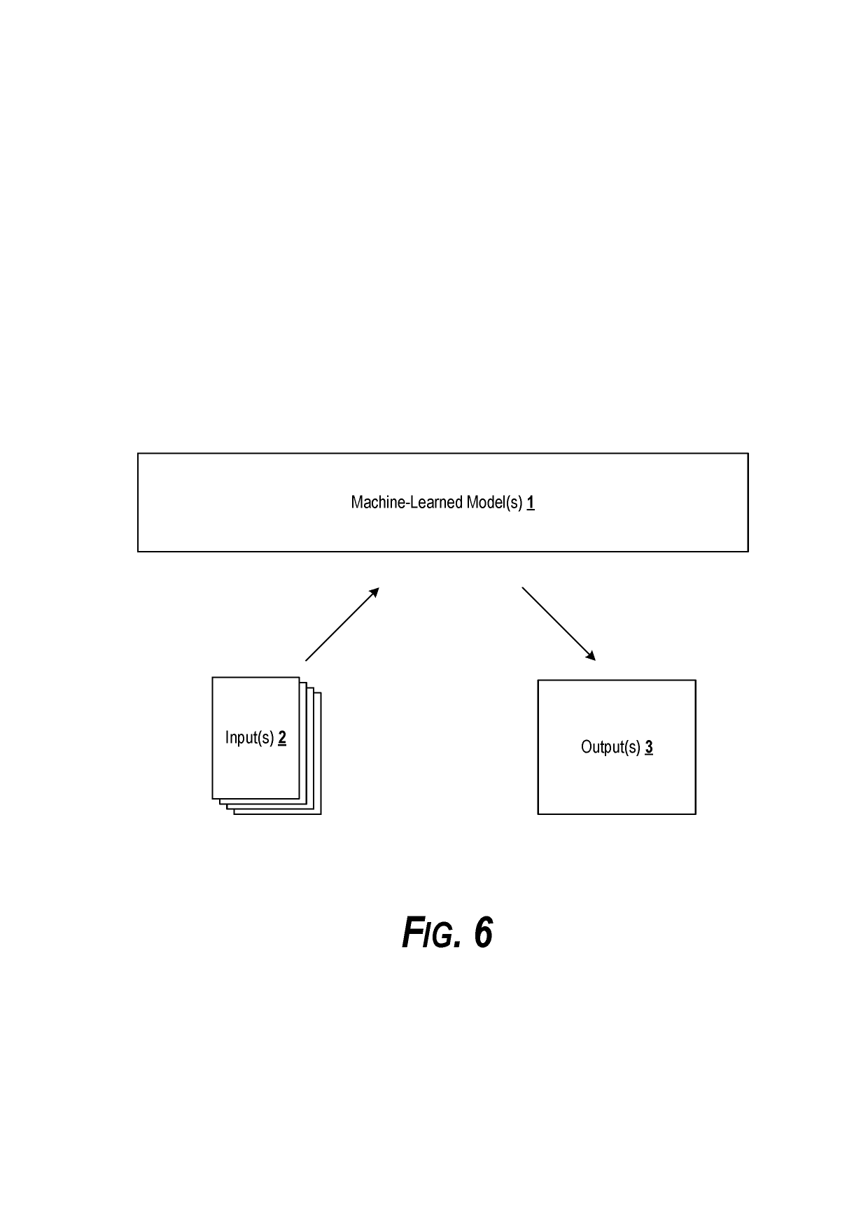

FIG. 6 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Machine-learned model(s) 1 can be or include, or otherwise be representative of any one or more of the machine-learned models described above with respect to the preceding figures. For example, machine-learned model(s) 1 can be or include, or otherwise be representative of any one or more of an agentic model, an interconnectivity graph, etc. Although various features, variations, and implementations described below are described with respect to machine-learned model(s) 1, it is to be understood that such features, variations, and implementations are to be understood as described with respect to each of an agentic model, an interconnectivity graph, etc., any other machine-learned component described herein.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include multiple different models or multiple different model portions configured to operate on data from input(s) 2.

Machine-learned model(s) 1 can include an ensemble of different models that can cooperatively interact to process data from input(s) 2. For example, a model ensemble can include multiple models that have different attributes (e.g., different architectures, trained with different recipes, etc.). The ensemble can output an overall output based on the individual outputs of the constituent models. In this manner, for instance, the diverse constituent models can work together to provide system-level robustness by effectively aggregating over individual strengths and weaknesses of any given model. The respective individual outputs can be combined in a weighted combination, using a voting or routing mechanism, or a learned output layer (e.g., one or more feedforward or fully-connected layers).

Machine-learned model(s) 1 can employ a mixture-of-experts structure. See, e.g., Zhou et al., Mixture-of-Experts with Expert Choice Routing, arXiv:2202.09368v2 (Oct. 14, 2022). For example, different portions of a model can learn (explicitly or implicitly) different expertise areas, with pathways through the model being selected by a learned routing mechanism that engages the appropriate expert for a given input (e.g., a given portion of an input, such as on a per-token basis). For example, a feedforward network can be sparsely activated for a given portion of an input based on an output of a routing mechanism that processes the portion of the input. In this manner, for instance, the group of activated weights can form an “expert” that is selected by the router. On each forward pass, only a subset of the total model weights may be engaged, thereby decreasing a quantity of operations performed for processing a given input compared to a densely activated model. In this manner, for instance, the expressive and interpretive power of a high-parameter-count model can be achieved with more compute-efficient forward passes.

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

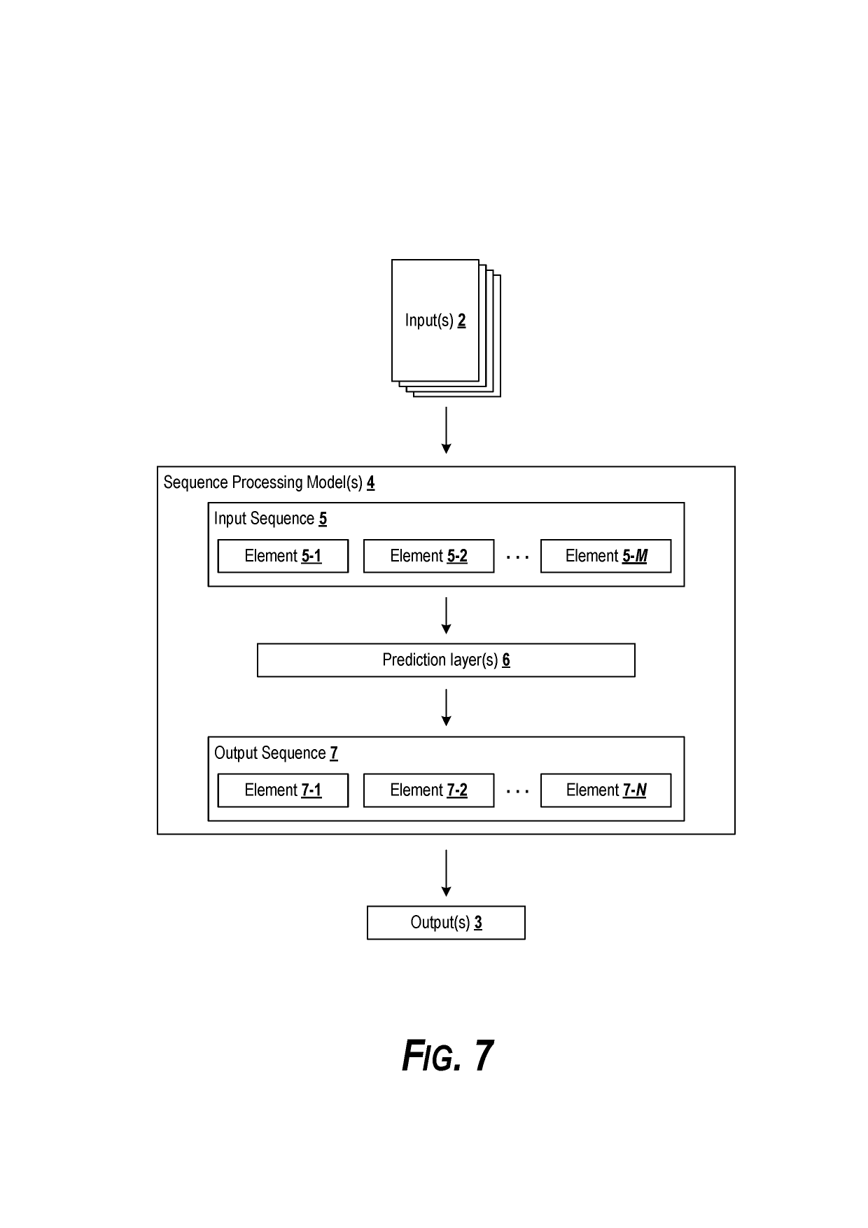

FIG. 7 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models are referred to as language models and can leverage language-based understandings across one or multiple modalities of input information. Sequence processing model(s) 4 can include relatively large models (e.g., more parameters, computationally expensive, etc.), which may be referred to as “Large Language Models” or LLMs. Sequence processing model(s) 4 can include relatively small models (e.g., fewer parameters, computationally lightweight, etc.), which may be referred to as “Small Language Models” or SLMs. Example language models include, for instance, models described in Gemma: Open Models Based on Gemini Research and Technology, Google, https://arxiv.org/abs/2403.08295; Gemma 2: Improving Open Language Models at a Practical Size, Google, https://arxiv.org/abs/2408.00118.

Sequence processing model(s) 4 can process one or multiple types of data simultaneously. Variations of language models that can perform joint vision and language tasks may be referred to as “Vision-Language Models,” or VLMs. Example VLMs include models described in PaliGemma: A versatile 3B VLM for transfer, Google, https://arxiv.org/abs/2407.07726; PaliGemma 2: A Family of Versatile VLMs for Transfer, Google, https://arxiv.org/abs/2412.03555; Flamingo: a Visual Language Model for Few-Shot Learning, Google, https://arxiv.org/abs/2204.14198; PaLI: A Jointly-Scaled Multilingual Language-Image Model, Google, https://arxiv.org/abs/2209.06794.

Sequence processing model(s) 4 can be multimodal. Example multimodal sequence processing models include, for instance, models described in Gemini: A Family of Highly Capable Multimodal Models, Google, https://arxiv.org/abs/2312.11805; Gemini 1.5: Unlocking multimodal understanding across millions of tokens of context, Google, https://arxiv.org/abs/2403.05530.

Other example sequence processing models can operate to generate outputs or receive inputs in specific domains, such as image domains, see, e.g., Dosovitskiy et al., An Image is Worth 16x16 Words: Transformers for Image Recognition at Scale, arXiv:2010.11929v2 (Jun. 3, 2021), audio domains, see, e.g., Agostinelli et al., MusicLM: Generating Music From Text, arXiv:2301.11325v1 (Jan. 26, 2023), biochemical domains, see, e.g., Jumper et al., Highly accurate protein structure prediction with AlphaFold, 596 Nature 583 (Aug. 26, 2021), by way of example.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, Proceedings of the 2018 Conference on Empirical Methods in Natural Language Processing (System Demonstrations), pages 66–71 (October 31–November 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 7 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter’s toolbox was small and heavy. It was full of ___.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, arXiv:1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, arXiv:2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

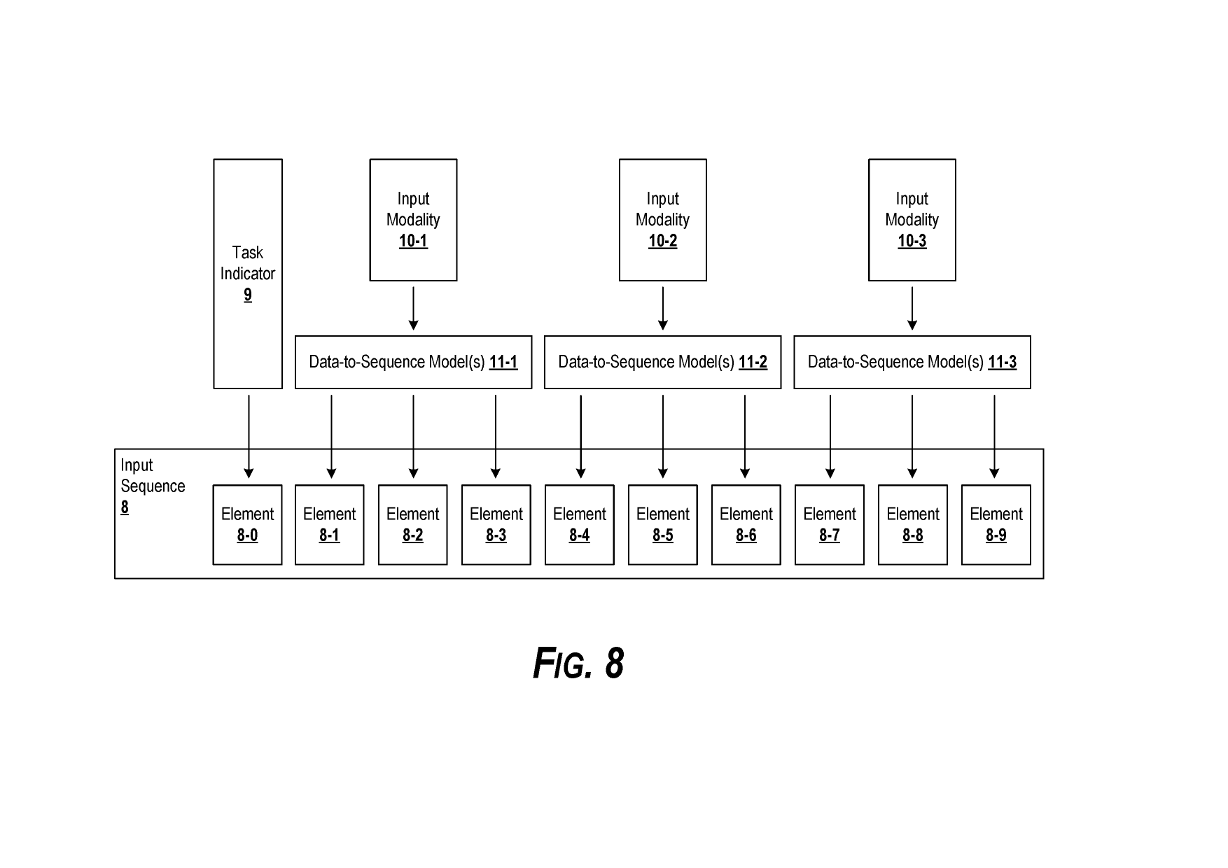

FIG. 8 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary data type data-to-sequence model can subdivide an input of that arbitrary data type and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

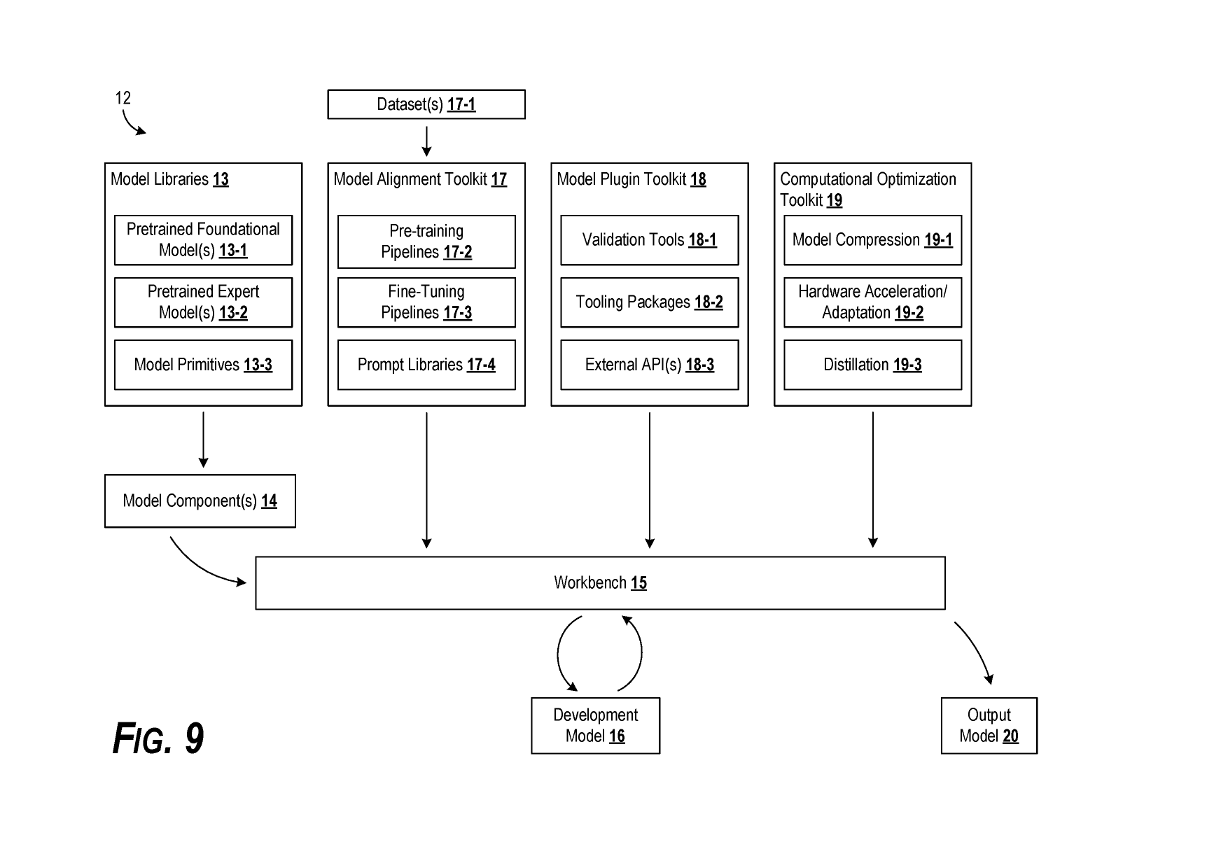

FIG. 9 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired. Model primitives 13-3 can include a library of pre-trained adapters or LoRA modules that can adapt a baseline foundational model to align its outputs with a desired performance profile, augment model capabilities (e.g., to adapt to a different input modality, etc.), and the like.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing the accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based on one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output an input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 500 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instructions that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

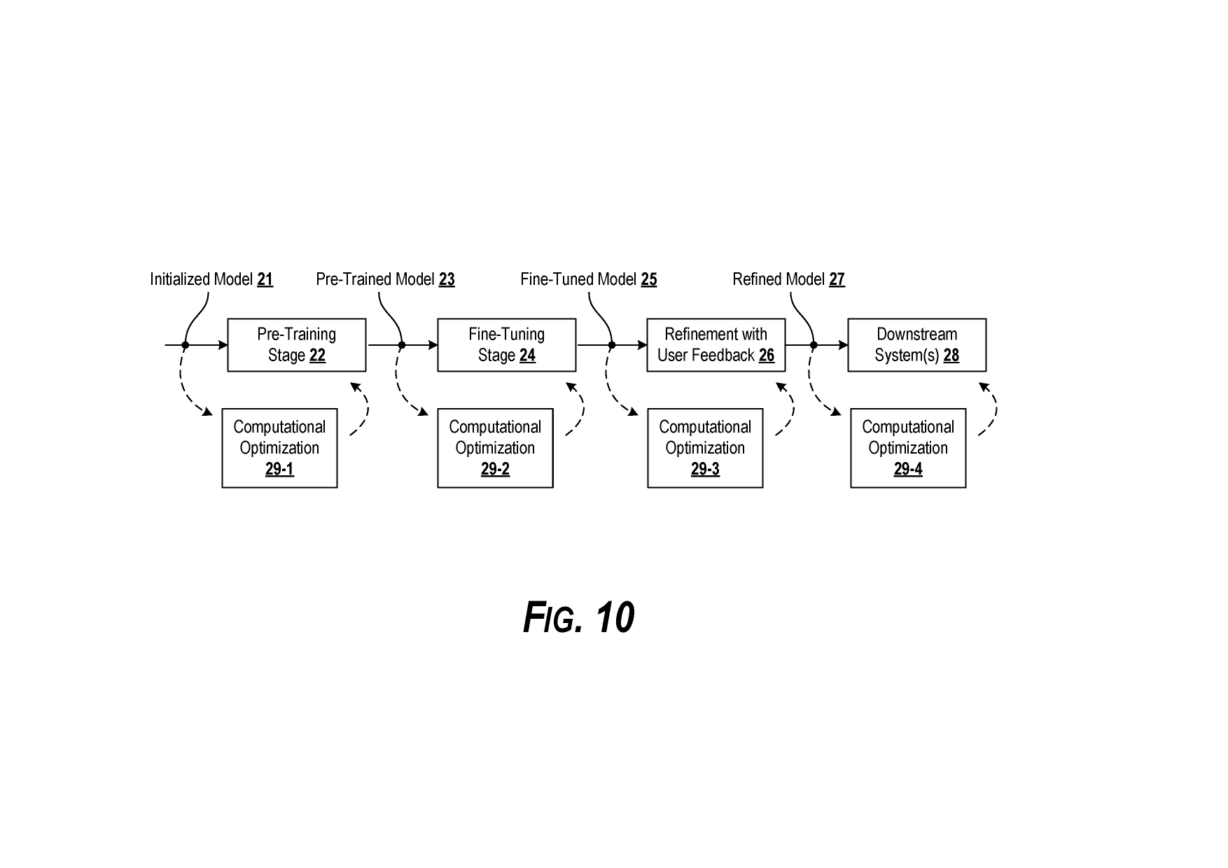

FIG. 10 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 10 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 10 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model has satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

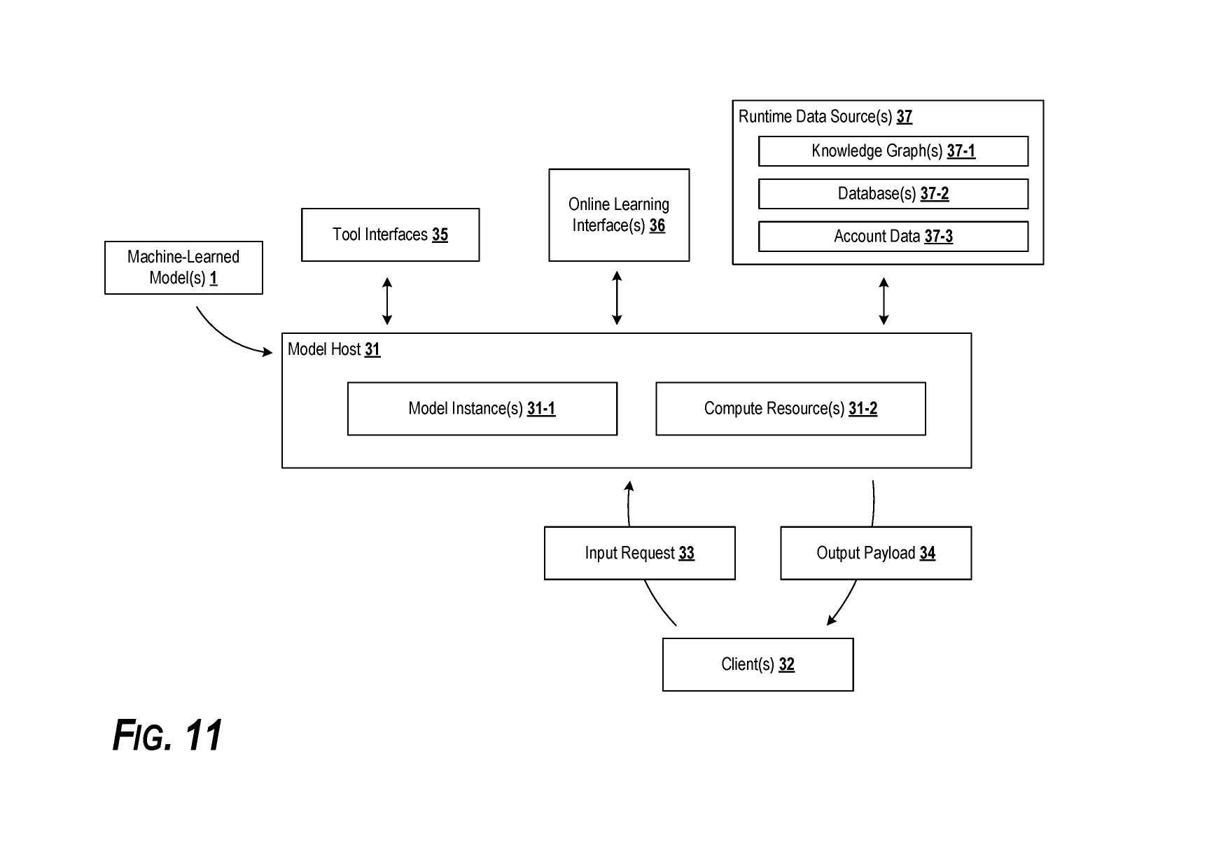

FIG. 11 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on the same device or system as client(s) 32. Model host 31 can be a machine-learning service that runs on-device to provide machine-learning functionality to one or multiple applications operating on a client device, which can include an application implementing client(s) 32. Model host 31 can be a part of the same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can access a library of pre-trained adapters or LoRA modules that can adapt a baseline model to align its outputs with a desired performance profile, augment model capabilities (e.g., to adapt to a different input modality, etc.), and the like. For instance, model host 31 can receive an input request to load a customized model, and model host 31 can retrieve one or more components to adapt a baseline model to the custom profile. Model host 31 can determine that a particular functionality is needed for a particular task (e.g., based on an output of a model that preprocesses an input) and retrieve a pre-trained component accordingly.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction-following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

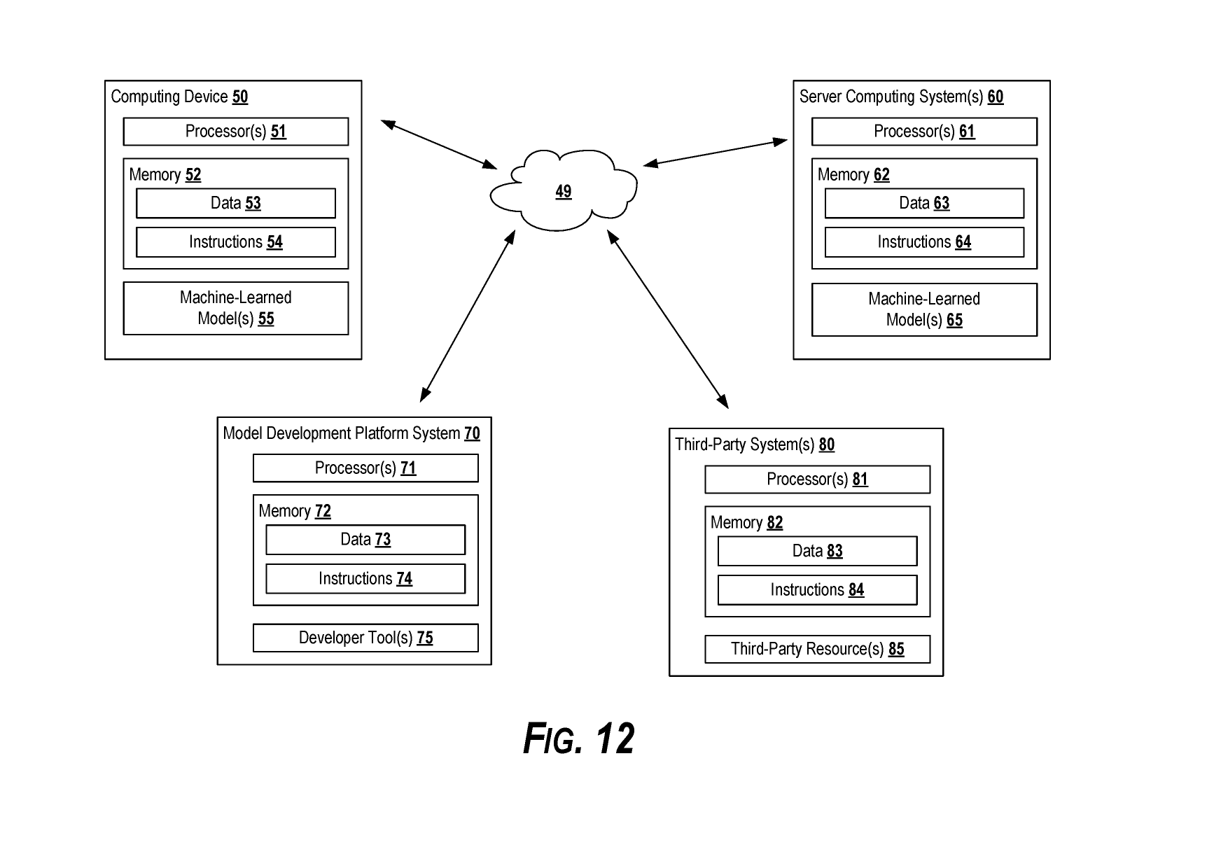

FIG. 12 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 12 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 12 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

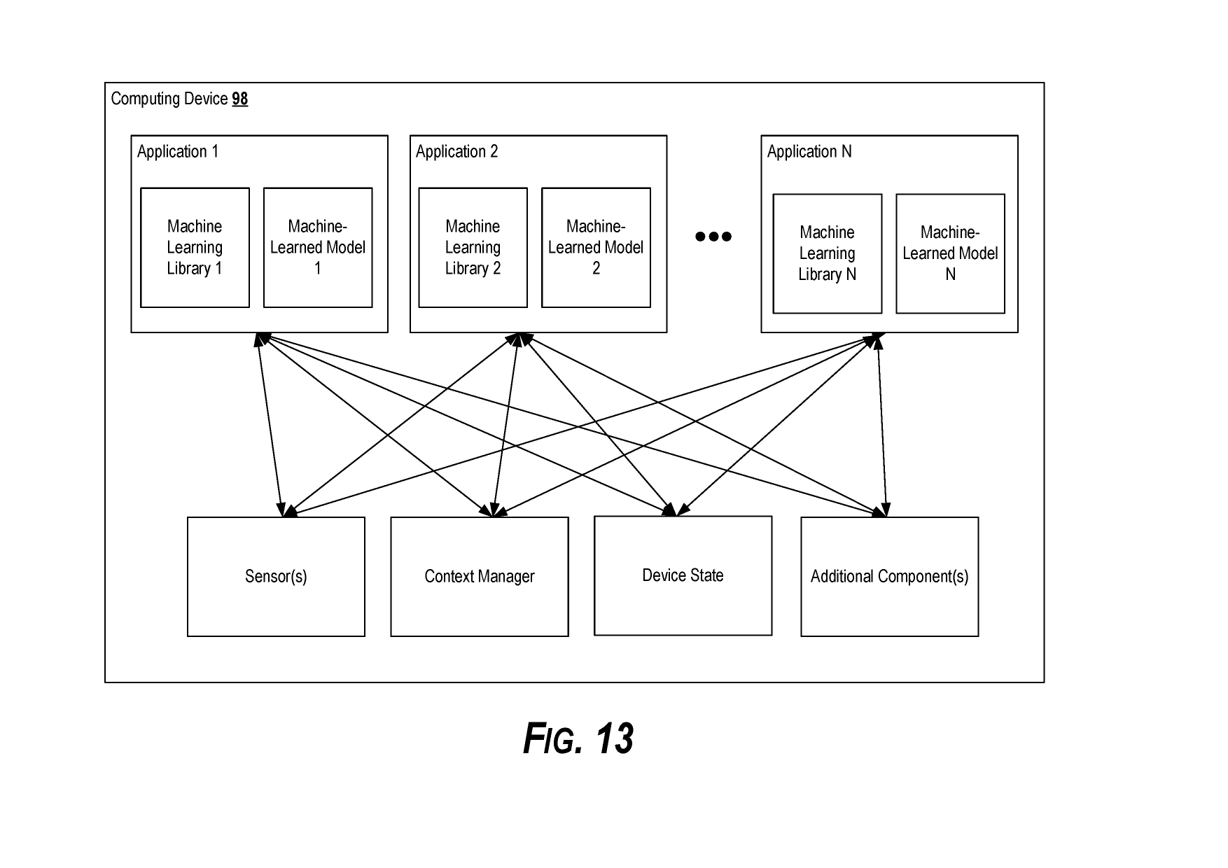

FIG. 13 is a block diagram of an example computing device 98 that performs dynamic selection of agentic models according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 13, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

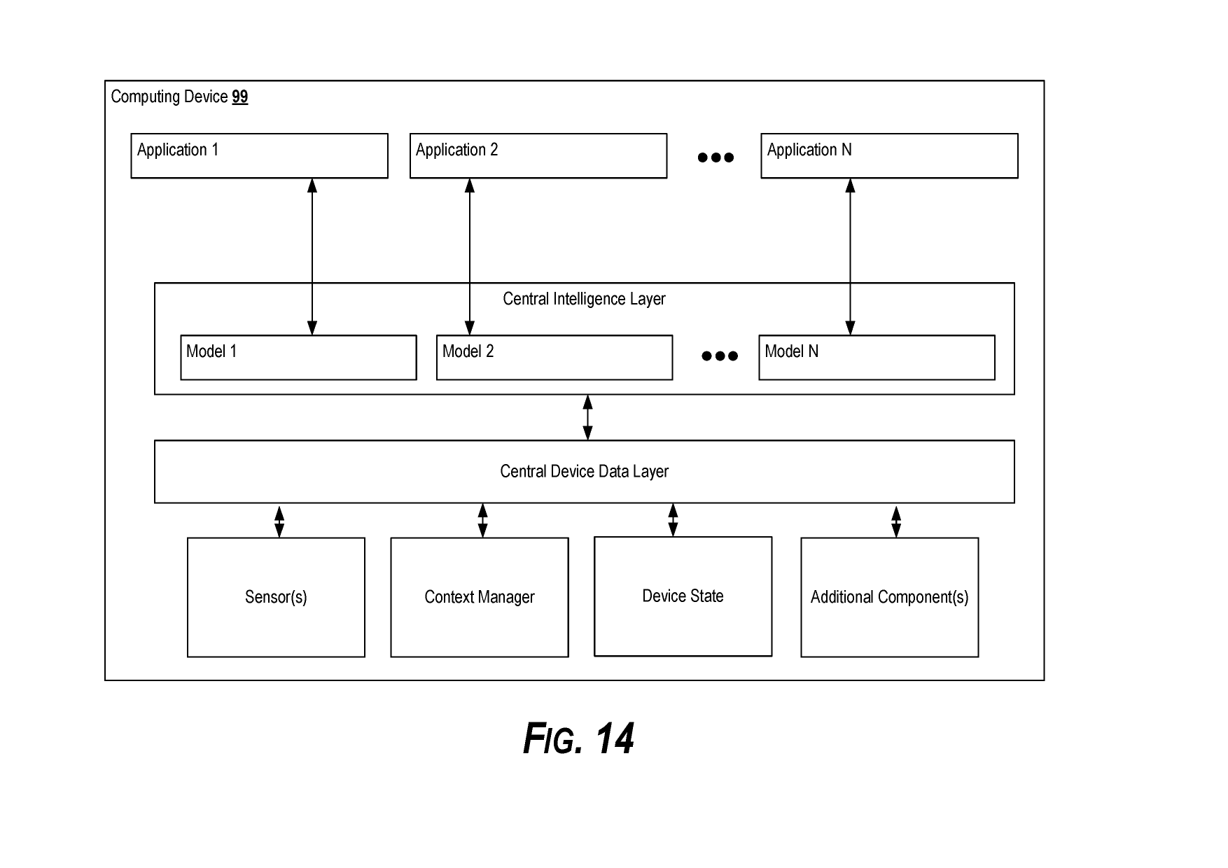

FIG. 14 is a block diagram of an example computing device 99 that performs dynamic selection of agentic models according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 14, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 14, the central device data layer can communicate with a number of other components of the computing device, such as, for example, one or more sensors, a context manager, a device state component, or additional components. In some implementations, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computer-implemented method, comprising:
accessing, by a computing system comprising one or more processor devices, relationship information for a first user indicative of relationships between the first user and a plurality of entities;
based on the relationship information, identifying, by the computing system, a plurality of agentic models, each of the plurality of agentic models representing a corresponding entity of the plurality of entities;
generating, by the computing system based on the relationship information, an interconnectivity graph comprising a plurality of nodes connected by a plurality of edges, wherein each of the plurality of nodes represents a corresponding agentic model of the plurality of agentic models, and wherein each edge of the plurality of edges comprises features derived from previous interactions associated with a pair of nodes connected by the edge;
processing, by the computing system using the interconnectivity graph, task information indicative of a particular task requested by the first user to obtain task routing information that identifies a first agentic model of the plurality of agentic models to complete the particular task; and
transmitting, by the computing system, the task information to the first agentic model.

2. The method of claim 1, wherein the method further comprises:
receiving, by the computing system, a first task output from the first agentic model.

3. The method of claim 2, wherein the interconnectivity graph comprises a learned interconnectivity graph comprising a plurality of learned values, and wherein the method further comprises:
evaluating, by the computing system, the first task output from the first agentic model to obtain a first quality score for the first task output; and
adjusting, by the computing system, at least one of the plurality of learned values of the learned interconnectivity graph based on the first quality score for the first task output.

4. The method of claim 3, wherein adjusting the at least one of the plurality of learned values of the learned interconnectivity graph based on the first quality score for the first task output comprises:
transmitting, by the computing system, the task information to a second agentic model different than the first agentic model;
receiving, by the computing system, a second task output from the second agentic model;
evaluating, by the computing system, the second task output from the second agentic model to obtain a second quality score for the second task output; and
responsive to the second quality score for the second task output being greater than the first quality score for the first task output, adjusting, by the computing system, the at least one of the plurality of learned values, wherein the at least one value is associated with one or more of:
a first edge of the plurality of edges that connects a first node associated with the first user to a second node associated with the first agentic model; or
a second edge of the plurality of edges that connects the first node associated with the first user to a third node associated with the second agentic model.

5. The method of claim 4, wherein a first learned value of the one or more learned values comprises a feature of the first edge.

6. The method of claim 2, wherein the first task output comprises a request for assistance with the particular task; and
wherein the method further comprises:
processing, by the computing system, the first task output using the interconnectivity graph to identify a second agentic model;
transmitting, by the computing system, information indicative of the second agentic model to the first agentic model; and
receiving, by the computing system, a complete task output comprising the first task output and a second task output generated by the second agentic model.

7. The method of claim 1, wherein the plurality of edges comprises a first edge that connects a first node to a second node of the plurality of nodes, wherein the first node represents a agentic model associated with the first user, and wherein the second node represents the first agentic model of the plurality of agentic models.

8. The method of claim 7, wherein the first edge comprises a plurality of features, comprising at least one of:
a communication between the agentic model associated with the first user and the first agentic model;
a communication between the first user and a first entity of the plurality of entities represented by the first agentic model; or
task-specific scoring information comprising a plurality of task scores for a respective plurality of task classifications, each of the plurality of task scores being indicative of an expected output quality for the first agent-based model when completing a task of a corresponding task classification.

9. The method of claim 8, wherein the plurality of features comprises the task-specific scoring information, and wherein processing the task information indicative of the particular task requested by the first user using the interconnectivity graph comprises:
processing, by the computing system, the task information to identify a particular task classification of the plurality of task classifications for the particular task; and
selecting, by the computing system, the first agentic model from the plurality of agentic models based on the task-specific scoring information.

10. The method of claim 8, wherein the method further comprises:
receiving, by the computing system, information indicative of a new communication between the agentic model associated with the first user and the first agentic model; and
adjusting, by the computing system, the first edge of the interconnectivity graph based on the information indicative of the new communication.

11. The method of claim 10, wherein adjusting the first edge of the interconnectivity graph comprises:
storing, by the computing system, at least a portion of the new communication to the first edge of the interconnectivity graph.

12. The method of claim 10, wherein the plurality of features further comprises the task-specific scoring information, and wherein adjusting the first edge of the interconnectivity graph comprises:
adjusting, by the computing system, a first task score of the plurality of task scores based on the new communication between the agentic model associated with the first user and the first agentic model.

13. The method of claim 10, wherein adjusting the first edge of the interconnectivity graph comprises:
removing, by the computing system, the first edge from the interconnectivity graph.

14. The method of claim 7, wherein the task routing information identifies a plurality of agentic models comprising the first agentic model and a second agentic model, wherein the second agentic model is connected to the first agentic model by a second edge of the plurality of edges within the interconnectivity graph.

15. The method of claim 14, wherein the task routing information assigns a first portion of the particular task to the first agentic model, and wherein the task routing information further assigns a second portion of the particular task to the second agentic model.

16. The method of claim 1, wherein the plurality of entities comprises a second user different than the first user, and wherein the relationship information comprises information descriptive of a previous exchange between the first user and the second user.

17. A computing system, comprising:
one or more processors; and
one or more non-transitory computer-readable media that store instructions that, when executed by one or more processors, cause the one or more processors to perform operations, the operations comprising:
receiving task information indicative of a particular task from a user computing device;
responsive to receiving the task information, accessing an interconnectivity graph associated with a particular user of the user computing device, wherein the interconnectivity graph comprises a plurality of nodes connected by a plurality of edges, wherein each of the plurality of nodes represents a corresponding agentic model of a plurality of agentic models, wherein each of the plurality of agentic models represents a corresponding entity of a plurality of entities with relationships to the user, and wherein each edge of the plurality of edges comprises features derived from previous interactions associated with a pair of nodes connected by the edge;
processing the task information with the interconnectivity graph to obtain task routing information that identifies a first agentic model of the plurality of agentic models to complete the particular task; and
transmitting the task information to the first agentic model.

18. The computing system of claim 17, wherein the operations further comprise:
receiving a first task output from the first agentic model.

19. The computing system of claim 18, wherein the operations further comprise:
evaluating the first task output from the first agentic model to obtain a first quality score for the first task output; and
adjusting the interconnectivity graph based on the first quality score for the first task output.

20. One or more non-transitory computer-readable media that store instructions that, when executed by the one or more processors, cause the computing system to perform operations, the operations comprising:
accessing relationship information for a first user indicative of known relationships between the first user and a plurality of entities;
based on the relationship information, identifying a plurality of agentic models, each of the plurality of agentic models representing a corresponding entity of the plurality of entities;
generating, based on the relationship information, an interconnectivity graph comprising a plurality of nodes connected by a plurality of edges, wherein each of the plurality of nodes represents a corresponding agentic model of the plurality of agentic models, and wherein each edge of the plurality of edges comprises features derived from previous interactions associated with a pair of nodes connected by the edge;
processing, using the interconnectivity graph, task information indicative of a particular task requested by the first user to obtain task routing information that identifies a first agentic model of the plurality of agentic models to complete the particular task; and
transmitting the task information to the first agentic model.
